(19) United States
(12) Patent Application Publication
(10) Pub. No.: US 2025/0059077 A1
(43) Pub. Date: Feb. 20, 2025

(54) PFAS REMOVAL AND DESTRUCTION USING BIOREACTORS FOLLOWED BY SUPERCRITICAL WATER OXIDATION

(71) Applicant: Evoqua Water Technologies LLC, Pittsburgh, PA (US)

(72) Inventors: Thomas Kenneth Mallmann, Rockford, IL (US); Simon P. Dukes, Chelmsford, MA (US); Joshua Griffis, Ashburnham, MA (US); Mohsen Ghafari, Chelmsford, MA (US)

(21) Appl. No.: 18/848,252

(22) PCT Filed: Mar. 14, 2023
(86) PCT No.: PCT/US2023/015175

§ 371 Date: Sep. 18, 2024

Related U.S. Application Data
(60) Provisional application No. 63/319,544, filed on Mar. 14, 2022.

(51) Int. Cl. C02F 9/00; C02F 1/28; C02F 1/42; C02F 3/12; C02F 11/08; C02F 11/12; C02F 101/10; C02F 101/16; C02F 101/34; C02F 101/36

(52) U.S. Cl. CPC C02F 9/00; C02F 1/283; C02F 1/285; C02F 3/1226; C02F 3/1268; C02F 11/086; C02F 1/42; C02F 2001/422; C02F 11/12; C02F 2101/101; C02F 2101/16; C02F 2101/34; C02F 2101/36; C02F 2101/40; C02F 2209/38; C02F 2209/40; C02F 2303/16; C02F 2305/06

(57) ABSTRACT

Systems and methods for treating water containing PFAS are disclosed. A bioreactor and a supercritical water oxidation (SCWO) system may be implemented to provide a complete chain of separation and destruction of PFAS to treat contaminated water. Adsorption media may be added to facilitate the removal of PFAS from water.

### CROSS-REFERENCE TO RELATED APPLICATION

This application claims priority to U.S. Provisional Patent Application Ser. No. 63/319,544, filed on Mar. 14, 2022 and titled “PFAS REMOVAL AND DESTRUCTION USING BIOREACTORS FOLLOWED BY SUPERCRITICAL WATER OXIDATION,” the entire disclosure of which is hereby incorporated herein by reference in its entirety for all purposes.

### FIELD OF TECHNOLOGY

Aspects and embodiments disclosed herein are generally related to the removal and elimination of per- and polyfluoroalkyl substances (PFAS) from water.

### BACKGROUND

There is rising concern about the presence of various contaminants in municipal wastewater, surface water, drinking water and groundwater. For example, perchlorate ions in water are of concern, as well as PFAS and PFAS precursors, along with a general concern with respect to total organic carbon (TOC).

PFAS are man-made chemicals used in numerous industries. PFAS molecules typically do not break down naturally. As a result, PFAS molecules accumulate in the environment and within the human body. PFAS molecules contaminate food products, commercial household and workplace products, municipal water, agricultural soil and irrigation water, and even drinking water. PFAS molecules have been shown to cause adverse health effects in humans and animals.

The U.S. Environmental Protection Agency (EPA) has issued a Contaminant Candidate List (CCL 5) which includes PFAS as a broad class inclusive of any PFAS that fits the revised CCL 5 structural definition of per- and polyfluoroalkyl substances (PFAS), namely chemicals that contain at least one of the following three structures:
R—(CF2)-CF(R′)R″, where both the CF2 and CF moieties are saturated carbons, and none of the R groups can be hydrogen.
R-CF2OCF2-R′, where both the CF2 moieties are saturated carbons, and none of the R groups can be hydrogen.
CF3C(CF3)RR′, where all the carbons are saturated, and none of the R groups can be hydrogen.

The EPA's Comptox Database includes a CCL 5 PFAS list of over 10,000 PFAS substances that meet the Final CCL 5 PFAS definition. The EPA has committed to being proactive as emerging PFAS contaminants or contaminant groups continue to be identified and the term PFAS as used herein is intended to be all inclusive in this regard.

### SUMMARY

In accordance with one or more aspects, a method of treating water containing per- and polyfluoroalkyl substances (PFAS) is disclosed. The method may comprise introducing the water containing PFAS to a bioreactor to produce an activated sludge containing adsorbed PFAS, wherein the PFAS is bioaccumulated on the activated sludge, and subjecting the activated sludge containing adsorbed PFAS to a supercritical water oxidation (SCWO) system.

In some aspects, the PFAS may comprise perfluorooctane sulfonic acid (PFOS) or perfluorooctanoic acid (PFOA).

In some aspects, the water containing PFAS may be defined by a chemical oxygen demand (COD) level of at least about 200 mg/L or a biochemical oxygen demand (BOD) level of at least about 100 mg/L. In some non-limiting aspects, the water containing PFAS may be defined by a total organic carbon (TOC) level of at least about 75 mg/L.

In some aspects, the method may further comprise dosing nutrient and/or biological oxygen demand (BOD) to the bioreactor.

In some aspects, the method may further comprise introducing adsorption media to the water containing PFAS or to the activated sludge containing adsorbed PFAS. The adsorption media may be a carbon-based media. In some non-limiting aspects, the adsorption media may be a powdered activated carbon (PAC). In other non-limiting aspects, the adsorption media may comprise a cyclodextrin (CD).

In some aspects, the method may further comprise dewatering the activated sludge containing adsorbed PFAS prior to the SCWO system. Likewise, the method may further comprise concentrating the water containing PFAS upstream of the bioreactor.

In some aspects, the method may further comprise introducing a selective ion to the SCWO system.

In some aspects, the method may further comprise adjusting the dosage of adsorption media based on at least one quality parameter of the water containing PFAS.

In some aspects, the method may further comprise adjusting a flow rate of the activated sludge containing adsorbed PFAS and/or an oxygen supply level associated with the SCWO system.

In some aspects, the SCWO system may be operated at a temperature of at least about 374° C. In at least some aspects, the SCWO system may be operated at a pressure of at least about 221 bar. In specific non-limiting aspects, the SCWO system may be operated at autothermal conditions.

In some aspects, the method may further comprise preheating the water containing PFAS and/or the activated sludge containing adsorbed PFAS upstream of the SCWO system.

In some aspects, the method may further comprise delivering product water at an outlet of the SCWO system to a downstream unit operation for polishing. The method may further comprise separating byproducts including nitrogen oxides (NOₓ) and/or sulfur oxides (SOₓ) and/or inorganic ash from product water at an outlet of the SCWO system.

In some aspects, the overall method may be associated with a PFAS removal rate of at least about 99%.

In some aspects, the SCWO system may be driven at least in part by a calorific value of the activated sludge containing adsorbed PFAS and/or the adsorption media.

In some aspects, the method may further comprise separating and regenerating the adsorption media.

In some aspects, the method may further comprise polishing an effluent stream associated with the bioreactor.

In accordance with one or more aspects, a system for treating water containing per- and polyfluoroalkyl substances (PFAS) is disclosed. The system may include a bioreactor having an inlet fluidly connectable to a source of water containing PFAS, and a supercritical water oxidation (SCWO) reactor fluidly connected downstream of the bioreactor.

In some aspects, the bioreactor may be a membrane bioreactor.

In some aspects, the system may further comprise a source of nutrient and/or BOD fluidly connected to the bioreactor.

In some aspects, the system may further comprise a source of adsorption media in communication with the bioreactor. The adsorption media may be bifunctional with respect to facilitating PFAS removal and driving the SCWO reactor. In certain non-limiting aspects, the adsorption media may comprise at least one material selected from the group consisting of: activated carbon, cyclodextrins, heterocyclic molecules, porphyrins, diatomaceous earth, neutral surfactants, ionic surfactants, inorganic media, alumina, activated alumina, aluminosilicates, zeolites, silica, perlite, metalorganic complexes and ion exchange resins.

In some aspects, the system may further comprise a concentration unit operation upstream of the bioreactor and/or the SCWO reactor. The system may further comprise a polishing unit operation fluidly connected to an effluent outlet of the bioreactor. In certain non-limiting aspects, the polishing unit operation may comprise a granular activated carbon (GAC), anion exchange resin, or adsorbent column.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in the various figures is represented by a like numeral. For purposes of clarity, not every component may be labeled in every drawing. In the drawings:

FIG. 1 presents a process flow diagram associated with systems and methods for treating water containing a per- or poly-fluoroalkyl substance (PFAS) in accordance with one or more embodiments;

FIG. 2 presents a modification of the process flow diagram of FIG. 1 involving introduction of adsorption media in accordance with one or more embodiments;

FIG. 3 presents a modification of the process flow diagram of FIG. 1 involving treatment of bioreactor effluent in accordance with one or more embodiments; and

FIG. 4 presents a modification of the process flow diagram of FIG. 1 involving introduction of a source of nutrient in accordance with one or more embodiments.

### DETAILED DESCRIPTION

In accordance with one or more embodiments, water containing a per- or poly-fluoroalkyl substance (PFAS) may be treated. Contaminated water may be biologically treated, for example by being introduced to a bioreactor, to produce an activated sludge containing adsorbed PFAS. The PFAS may generally become bioaccumulated on the activated sludge. The activated sludge may then be treated to eliminate PFAS prior to environmental discharge. Specifically, the PFAS may be mineralized via supercritical water oxidation (SCWO) of the activated sludge. Adsorption media may be used to augment the bioreactor in terms of PFAS removal efficiency and may further drive the SCWO system to effect PFAS destruction. Beneficially, PFAS treatment may be performed in an efficient and effective manner as described further herein.

Removal of PFAS from complex water matrices with high organic matter content is a challenge using conventional technologies. Additionally, most of the existing PFAS treatment processes remove PFAS from water, but do not destroy them, which means PFAS still remain persistent in the environment. In accordance with one or more embodiments, a process train is disclosed to cost-effectively separate and eventually destroy PFAS. The disclosed embodiments may serve as a complete PFAS removal and destruction process train that represent a differentiation from current offerings by eliminating the needs and the costs associated with management and disposal of PFAS concentrated waste streams.

PFAS are organic compounds consisting of fluorine, carbon and heteroatoms such as oxygen, nitrogen and sulfur. PFAS is a broad class of molecules that further includes polyfluoroalkyl substances. PFAS are carbon chain molecules having carbon-fluorine bonds. Polyfluoroalkyl substances are carbon chain molecules having carbon-fluorine bonds and also carbon-hydrogen bonds. Common PFAS molecules include perfluorooctanoic acid (PFOA), perfluorooctanesulfonic acid (PFOS), and short-chain organofluorine chemical compounds, such as the ammonium salt of hexafluoropropylene oxide dimer acid (HFPO-DA) fluoride (also known as GenX). PFAS molecules typically have a tail with a hydrophobic end and an ionized end. The hydrophobicity of fluorocarbons and extreme electronegativity of fluorine give these and similar compounds unusual properties. Initially, many of these compounds were used as gases in the fabrication of integrated circuits. The ozone destroying properties of these molecules restricted their use and resulted in methods to prevent their release into the atmosphere. But other PFAS such as fluoro-surfactants have become increasingly popular. PFAS are commonly use as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply. Further, PFAS have been utilized as key ingredients in aqueous film forming foams (AFFFs). AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition. PFAS in AFFFs have contaminated the groundwater at many of these sites and refineries, including more than 100 U.S. Air Force sites.

Although used in relatively small amounts, these compounds are readily released into the environment where their extreme hydrophobicity as well as negligible rates of natural decomposition results in environmental persistence and bioaccumulation. It appears as if even low levels of bioaccumulation may lead to serious health consequences for contaminated animals such as human beings, the young being especially susceptible. The environmental effects of these compounds on plants and microbes are as yet largely unknown. Nevertheless, serious efforts to limit the environmental release of PFAS are now commencing.

It may be desirable to have flexibility in terms of what type of approach is used for treating water containing PFAS. For example, the source and/or constituents of the process water to be treated may be a relevant factor. The properties of PFAS compounds may vary widely, for example between long chain, short chain and ultrashort chain PFAS compounds. Various federal, state and/or municipal regulations may also be factors. The U.S. Environmental Protection Agency (EPA) developed revised guidelines in May 2016 of a combined lifetime exposure of 70 parts per trillion (PPT) for PFOS and PFOA. In June 2022, this EPA guidance was tightened to a recommendation of 0.004 ppt lifetime exposure for PFOA and 0.02 ppt lifetime exposure for PFOS. Federal, state, and/or private bodies may also issue relevant regulations. Market conditions may also be a controlling factor. These factors may be variable and therefore a preferred water treatment approach may change over time.

Use of various adsorption media is one technique for treating water containing PFAS. Activated carbon and ion exchange resin are both examples of adsorption media that may be used to capture PFAS from water to be treated. Such techniques may be used alone or in conjunction.

Conventional activated carbon adsorption systems and methods to remove PFAS from water have shown to be effective on the longer alkyl chain PFAS but have reduced bed lives when treating shorter alkyl chain compounds. Activated carbon treated with a surfactant can have increased bed life. Some conventional anion selective exchange resins have shown to be effective on the longer alkyl chain PFAS but have reduced bed lives when treating shorter alkyl chain compounds.

Membrane processes such as nanofiltration and reverse osmosis have been used for PFAS removal. Normal oxidative processes have heretofore been unsuccessful in oxidizing PFAS. Even ozone has been reported to be an ineffective oxidant. There have been reports of PFAS moieties being destroyed by combined oxidative technologies such as ozone plus UV or use of specialized anodes to selectively oxidize PFAS. Such techniques may be used in conjunction with the various embodiments disclosed herein.

In accordance with one or more embodiments, there is provided systems and methods of treating water containing PFAS. The water may contain at least 10 ppt PFAS, for example, at least 1 ppb PFAS. For example, the waste stream may contain at least 10 ppt-1 ppb PFAS, at least 1 ppb-10 ppm PFAS, at least 1 ppb-10 ppb PFAS, at least 1 ppb-1 ppm PFAS, or at least 1 ppm-10 ppm PFAS.

In certain embodiments, the water to be treated may include PFAS with other organic contaminants. One issue with treating PFAS compounds in water is that the other organic contaminants compete with the various processes to remove PFAS. For example, if the level of PFAS is 80 ppb and the background total organic carbon (TOC) is 50 ppm, a conventional PFAS removal treatment, such as an activated carbon column, may exhaust very quickly. Thus, it may be important to remove TOC prior to treatment to remove PFAS or turn to solutions that can readily handle PFAS removal at high TOC levels. In accordance with one or more embodiments, competitive adsorption of PFAS may be addressed.

In some embodiments, the systems and methods disclosed herein may be used to address background TOC while treating the water for removal of PFAS. The methods may be useful for oxidizing target organic alkanes, alcohols, ketones, aldehydes, acids, or others in the water. In some embodiments, the water containing PFAS further may contain at least 1 ppm TOC. For example, the water containing PFAS may contain at least 1 ppm-10 ppm TOC, at least 10 ppm-50 ppm TOC, at least 50 ppm-100 ppm TOC, or at least 100 ppm-500 ppm TOC.

In accordance with one or more specific non-limiting embodiments for illustration purposes only, typical concentration of organics in untreated domestic wastewater may be characterized by a biochemical oxygen demand (BOD) level of about 110 to about 350 mg/L, a chemical oxygen demand (COD) level of about 250 to about 800 mg/L and/or a total organic carbon (TOC) level of about 80 to about 260 mg/L. Various embodiments disclosed herein may find particular utility in connection with high organic concentration wastewater.

In accordance with one or more embodiments, PFAS may be removed from water via biological treatment. Biological treatment generally makes use of natural cellular processes to facilitate the decomposition of organic substances. Biological wastewater treatment is often used as a secondary treatment process to remove material remaining after primary treatment with processes including screening and dissolved air flotation (DAF) which remove sediments and oil from the wastewater.

In accordance with one or more embodiments, a bioreactor may be used to remove PFAS from water. Without wishing to be bound by any particular theory, extracellular polymeric substances (EPS) and proteins produced by microbial species can act as bridges to adsorb PFAS on microbial sludge. The bioreactor may mineralize biodegradable organic compounds and leaving only non-biodegradable compounds including PFAS to be adsorbed via other pathways as described herein. For example, the PFAS may be adsorbed onto powdered activated carbon (PAC) thus increasing PAC lifetime by reducing competitive adsorption. Use of the bioreactor, alone or particularly in conjunction with and adsorption media as disclosed further herein may be associated with high PFAS uptake in a removal operation. Beneficially, bioreactors such as membrane bioreactor systems have low operating costs compared to reverse osmosis (RO) that require high operating pressure and/or anion-exchange resins that requires frequent regeneration and replacement.

The systems and methods disclosed herein relate to treatment of organic material under aerobic or anaerobic conditions. Anaerobic digestion of biomass has been implemented for many years. In anaerobic digestion, a mixed culture of bacteria mediates the degradation of the putrescible fraction of organic matter ultimately to methane, carbon dioxide, and mineralized nutrients. Upon storage, biomass begins this process of degradation resulting in the production of intermediate compounds, which are volatile and often a source of odors. Since methanogenic microorganisms grow slowly and are present in limited numbers in fresh biomass, these volatile intermediates accumulate in stored biomass. In an effective anaerobic digester, the growth of methanogens is promoted such that the intermediate compounds are converted to biogas and nutrients, and the odor potential of the biomass is greatly reduced. Additionally, biogas is recovered and converted to heat energy which can be used as heat for various process in the facility or the biogas can be converted to electrical energy.

The principal means for promoting methanogenic growth in anaerobic digestion of biomass are controlling the operating temperature and/or controlling the residence time of the bacteria within the process. The types of anaerobic digester that have been implemented in the digestion of biomass are rather limited due to the nature of biomass as a substrate. The digester types have included variations of batch and semi-continuous processes, which include plug-flow digesters, complete-mix digesters, covered lagoons, and continuously stirred reactors.

During anaerobic treatment, an organic material slurry may be directed to a tank or reactor comprising anaerobic microorganisms. The anaerobic microorganisms convert biologically degradable material in the wastewater primarily into water, biogas, and biosolids. In particular, anaerobic microorganisms facilitate decomposition of macromolecular organic matter into simpler compounds and biogas by methane fermentation. Exemplary anaerobic microorganisms include methanogens and acetogens. The produced biogas is primarily carbon dioxide and methane but may include other constituents depending on the composition of the slurry.

Anaerobic treatment may generally refer to situations in which the prevailing conditions of the slurry within the tank or reactor are anaerobic. The tank or reactor may be closed. The tank or reactor may be open. In particular, even in embodiments in which the anaerobic treatment tank or reactor is open, anaerobic treatment may occur in the absence of added oxygen when the prevailing conditions in the water are anaerobic.

Aerobic treatment is a biological wastewater treatment process that takes place in the presence of oxygen. Aerobic biomass converts organics in the wastewater into carbon dioxide and now biomass. Aerobic treatment technologies can act as stand-alone systems for treating raw wastewater, or can be used to polish anaerobically pretreated wastewater to further remove biochemical oxygen demand (BOD) and total suspended solids (TSS). Aerobic technologies can also be used specifically as a biological nutrient removal system (BNR) to remove nitrogen and phosphorus.

Oxygen transfer efficiency is paramount for aerobic treatment and may be accomplished in various ways. In some embodiments, fine or coarse bubble diffusers may be implemented for mixing and/or delivering oxygen to wastewater. In other embodiments, floating mechanical aerators or mixers may increase surface area for atmospheric pressure to drive oxygen into the water for aeration. Aerobic and anaerobic treatment techniques are commonly known to those skilled in the relevant art.

In accordance with one or more embodiments, a bioreactor for biological treatment may be a membrane bioreactor (MBR). An MBR may serve as an activated sludge treatment system that improves treatment performance and consistency compared to conventional activated sludge systems by using a physical membrane barrier for liquid-solids separation instead of traditional gravity clarification. MBR may aerobically polish anaerobically pretreated wastewater, or may be used as a stand-alone process. The long solids retention time and physical membranes of the MBR generally work together to provide more consistent removal of organics, ammonia, and nitrogen than conventional activated sludge systems. The biochemical oxygen demand (BOD) and total suspended solids (TSS) concentrations discharged from the process are negligible, and very low effluent phosphorus concentrations can also be reached. In some non-limiting embodiments, MBR may operate at high mixed liquor suspended solids (MLSS) concentrations, for example, about 8,000 to about 15,000 mg/l. Other types of aerobic biological treatment systems include aerobic tanks, oxidation ditches, trickling filters, activated sludge and fixed film systems.

Microorganism growth may be promoted by addition of microorganisms during start-up and/or dosing with microorganism nutrients. Operating temperature, residence time of the bacteria within the digestor, and/or mixing conditions are important parameters.

In accordance with one or more embodiments, optimizing the biology of biological treatment may improve PFAS adsorption across a broader spectrum of PFAS compounds. Preferred microbial species may vary depending on the composition of water to be treated.

In accordance with one or more embodiments, a nutrient dosing system may be added to the bioreactor for a faster microbial growth if the BOD and inorganic nutrients in the water are not sufficient.

In accordance with one or more embodiments, adsorption media may be used to supplement removal of PFAS from water. Adsorption media may be introduced to the bioreactor, upstream of the bioreactor or downstream of the bioreactor to augment biological treatment via competitive adsorption.

In some embodiments, the removal material, e.g., adsorption media, used to remove the PFAS can be any suitable removal material, e.g., adsorption media, that can interact with the PFAS in the water to be treated and effectuate its removal, e.g., by being loaded onto the removal material. Carbon-based removal materials, e.g., activated carbon, and resin media are both widely used for the removal of organic and inorganic contaminates from water sources. For example, activated carbon may be used as an adsorbent to treat water. In some embodiments, the activated carbon may be made from bituminous coal, coconut shell, or anthracite coal. The activated carbon may generally be a virgin or a regenerated activated carbon. In some embodiments, the activated carbon may be a modified activated carbon. The activated carbon may be present in various forms, i.e., a granular activated carbon (GAC) or a powdered activated carbon (PAC).

In accordance with one or more embodiments, GAC may refer to a porous adsorbent particulate material, produced by heating organic matter, such as coal, wood, coconut shell, lignin or synthetic hydrocarbons, in the absence of air, characterized that the generally the granules or characteristic size of the particles are retained by a screen of 50 mesh (50 screen openings per inch in each orthogonal direction).

Without wishing to be bound by any particular theory, PAC typically has a larger surface area for adsorption that GAC and can be agitated and flowed more easily, increasing its effective use.

In some embodiments, the activated carbon used for adsorption removal of PFAS may be modified to enhance its ability to remove negatively charged species from water, such as deprotonated PFAS. For example, the PAC or GAC may be coated in a positively charged surfactant that preferentially interacts with the negatively charged PFAS in solution. The positively charged surfactant maybe a quaternary ammonium-based surfactant, such as cetyltrimethylammonium chloride (CTAC). Various activated carbon media for water treatment are known to those of ordinary skill in the art. In at least some non-limiting embodiments, the media may be an activated carbon as described in U.S. Pat. Nos. 8,932,984 and/or 9,914,110, both to Evoqua Water Technologies LLC, the entire disclosure of each of which is hereby incorporated herein by reference in its entirety for all purposes.

In accordance with one or more embodiments, the bioreactor may remove COD which would otherwise compete with PFAS in terms of adsorption on adsorption media, e.g. carbon. Extracellular substances may also attach to the PFAS for enhanced PFAS removal.

In some embodiments, separation of PFAS from a source of contaminated water may be achieved using an adsorption process, where the PFAS are physically captured in the pores of a porous material (i.e., physisorption) or have favorable chemical interactions with functionalities on a filtration medium (i.e., chemisorption). In accordance with one or more embodiments, a PFAS separation stage may include adsorption onto an electrochemically active substrate. An example of an electrochemically active substrate that can be used to adsorb PFAS is PAC or GAC which, compared to other PFAS separation methods, is a low-cost solution to remove PFAS from water that can potentially avoid known issues with other removal methods, such as the generation of large quantities of hazardous regeneration solutions of ion exchange vessels and the lower recovery rate and higher energy consumption of membrane-based separation methods such as nanofiltration and reverse osmosis (RO).

The removal material as described herein is not limited to particulate media, e.g., activated carbons, or cyclodextrins. Any suitable removal material, e.g., adsorption media, may be used to adsorb or otherwise bind with pollutants and contaminants present in the waste stream, e.g., PFAS. For example, suitable removal material may include, but are not limited to, alumina, e.g., activated alumina, aluminosilicates and their metal-coordinated forms, e.g., zeolites, silica, perlite, diatomaceous earth, surfactants, ion exchange resins, and other organic and inorganic materials capable of interacting with and subsequently removing contaminants and pollutants from the waste stream.

In certain non-limiting embodiments, this disclosure describes water treatment systems for removing PFAS from water and methods of treating water containing PFAS. Systems described herein include a contact reactor containing a removal material, e.g., an adsorption media, that has an inlet fluidly connected to a source of water containing PFAS. The removal material, after being exposed to PFAS and removing it from the water, may become loaded with PFAS. Treated water, i.e., water containing a lower concentration of PFAS than the source water may be separated from the removal material, e.g., adsorption media. In accordance with one or more embodiments, loaded adsorption media, e.g. PAC, GAC or ion exchange resin, may be further processed as disclosed further herein.

In some embodiments, the dosage of adsorption media may be adjusted based on at least one quality parameter of the water to be treated. For example, the at least one quality parameter may include a target concentration of the PFAS in the treated water to be at or below a specified regulatory threshold. Use of adsorption media may be considered optional and may be added selectively, for example, if breakthrough PFAS is detected upon sampling.

In accordance with one or more embodiments, a water treatment system may include a source of water connectable by conduit to an inlet of an upstream separation system that can produce a treated water and a stream enriched in PFAS. This upstream separation system may thus concentrate the water to be treated with respect to its PFAS content. A first separation system can be any suitable separation system that can produce a stream enriched in PFAS or other compounds. For example, the upstream separation system can be a membrane concentrator with an optional dynamic membrane, reverse osmosis (RO) system, a nanofiltration (NF) system, an ultrafiltration system (UF), or electrochemical separations methods, e.g., electrodialysis, electrodeionization, etc. In such implementations, the reject, retentate or concentrate streams from these types of separation systems will include water enriched in PFAS. For example, the concentration increase of PFAS in the water upon concentrating may be at least 20× relative to the initial concentration of PFAS before concentration, e.g., at least 20×, at least 25×, at least 30×, at least 35×, at least 40×, at least 45×, at least 50×, at least 55×, at least 60×, at least 65×, at least 70×, at least 75×, at least 80×, at least 85×, at least 90×, at least 95×, or at least 100×. In some embodiments of the system, water from the source of water, or another source of PFAS containing water, can be directed into the bioreactor via conduit without the need for upstream separation to produce a stream of water enriched in PFAS. In other embodiments, water from an upstream concentration process may be directed to the bioreactor.

The treated water produced by the system downstream of the bioreactor may be substantially free of the PFAS. The treated water being “substantially free” of the PFAS may have at least 90% less PFAS by volume than the waste stream. The treated water being substantially free of the PFAS may have at least 92% less, at least 95% less, at least 98% less, at least 99% less, at least 99.9% less, or at least 99.99% less PFAS by volume than the waste stream. Thus, in some embodiments, the systems and methods disclosed herein may be employed to remove at least 90% of PFAS by volume from the source of water. The systems and methods disclosed herein may remove at least 92%, at least 95%, at least 98%, at least 99%, at least 99.9%, or at least 99.99% of PFAS by volume from the source of water. In certain embodiments, the systems and methods disclosed herein are associated with a PFAS removal rate of at least about 99%, e.g., about 99%, about 99.1%, about 99.2%, about 99.3%, about 99.4%, about 99.5%, about 99.6%, about 99.7%, about 99.8%, about 99.9%, about 99.95%, or about 99.99%.

In accordance with one or more embodiments, activated sludge containing PFAS may be directed to a supercritical water oxidation (SCWO) system for destruction. Thus, in some embodiments, a train of processes comprising a bioreactor and super critical water oxidation is disclosed for a complete chain of separation and destruction of PFAS to treat contaminated waters. Through the use of these processes, PFAS is removed and fully destructed in a cost-effective, energy-efficient, and sustainable way with minimum risk of generating hazardous byproducts.

In accordance with one or more embodiments, an activated sludge from the bioreactor or other biological treatment may be subjected to a dewatering operation prior to further downstream treatment. For example, a centrifuge or press may be used for dewatering prior to the SCWO system.

In SWCO, water is heated and pressurized to a point past its critical point where vapor and liquid phases can coexist, and the resulting supercritical fluid is used as an oxidant along with O₂ gas that dissolves into the supercritical water. For water, the critical point occurs at a temperature and pressure are above 374° C. and 221 bar, respectively, and in some embodiments, systems and methods of the disclosure are operated at temperatures and pressures equal to and/or above these values. A unique property of supercritical water is that the solubility of gases and organic compounds is increased to close to full solubility while inorganic compounds become almost insoluble. Thus, gases and organic compounds entering a SCWO process undergo near-complete destruction into carbon dioxide and water. Further, the lower overall temperature of the reaction, i.e., less than 374° C., reduces the formation of unwanted byproducts such as hydrofluoric acid (HF), nitrogen oxides (NOₓ) and sulfur oxides (SOₓ) that would require additional separation. The removal of these waste products, should they form, can be performed by methods known in the art.

SCWO is generally a fully enclosed process and the reaction products are discharged at standard atmospheric pressures and temperatures, i.e., 1 atmosphere and 25° C. As discussed herein, the resulting products of SCWO are largely benign, consisting mainly of CO₂, water, and N₂. As the purity of these products is high coming out of a SCWO reactor, there is no need for scrubbing or other treatment processes to make them suitable for discharge to the environment. Waste streams including organic and inorganic halogens are converted to the corresponding haloacids, and organic and inorganic sulfur species are converted to sulfuric acid. These species are generally easier to remove from a liquid stream than as gases such as SO₂. Heavy metals in the waste stream are oxidized to their highest oxidation state and are separated together with any inert materials as a fine, non-leachable ash which can be used much like power station ash for landscaping, aggregates and similar applications, or simply landfilled.

In accordance with one or more embodiments, the activated sludge and/or any adsorption media containing PFAS is used as the fuel for the SWCO reactor. Prior to the SCWO reactor beginning its cycle, a selective ion may be added to coordinate with or sequester any potential reactions that may occur within the SCWO reactor. For example, PFAS contain large amounts of fluorine which has the potential to produce hydrofluoric acid (HF) that can damage the SCWO reactor. The addition of a selective ion, such as calcium (Ca²⁺), e.g., calcium gluconate or other soluble calcium salt, to form a stable mineral product can remove excess fluorine from the SCWO reactor. The oxidation process in the SCWO reactor destroys the PFAS-loaded removal material, producing condensed water, carbon dioxide (CO₂) gas, reactive gases, e.g., SOₓ and NOₓ, and residual ash that did not combust during the oxidation process. As discussed herein, the condensate water and the CO₂ produced from the SCWO process are of high purity and can be discharged out of the system without additional treatment. In some embodiments, the condensate water may be directed to the treated water of the system should its quality be sufficient. The ash and reactive gases, e.g., NOₓ and SOₓ, that are produced as byproduct can be dealt with in an appropriate manner. The ash can be recycled for mineral content or disposed of in a landfill. The gases can be collected and scrubbed as needed or used for acid production.

As discussed herein, SCWO is an energy intensive process that can proceed under autoignition, e.g., autothermal, conditions once the requisite temperature and pressure conditions are satisfied. Additional heat may be needed to reach the autoignition or autothermal point. In some embodiments, the system includes a heater to increase the temperature of the activated sludge and/or adsorption media entering the SCWO reactor if the calorific value, i.e., heat of combustion, is insufficient to permit the SCWO reactor to operate under autothermal conditions. The heater may be any suitable heater, such as a resistive heater, heat exchanger, tube-in-tube heater, or other similar heating device. For passive heaters, e.g., heat exchangers, existing waste heat from the SCWO reactor may be used.

As discussed herein, SCWO is an autothermal, or self-sustaining, oxidation process once the SCWO reactor is up to operating temperature. Prior to achieving operating temperature, the input of energy is required to heat and pressurize the water. This energy input has until recently limited the large scale use of SCWO. Like other related combustion technologies, the source of fuel for the autothermal reaction, e.g., a removal material, e.g., adsorption media or activated sludge, laden with adsorbed pollutants like PFAS, requires a modest concentration of organic matter to reach the autoignition point, approximately about 4-5% by mass. Without wishing to be bound by any particular theory, there exists a relationship between the physical density of the waste stream used as fuel for the SCWO reactor and operating the reactor itself. In general, fuel of maximum calorific value, i.e., density, is desirable to reach the autothermal point. The fuel used in a SWCO reactor is generally a slurry stream of organic solids and organic liquids. If the slurry stream is too dense, the SCWO reactor distribution components may clog or otherwise become too rich in fuel and operate inefficiently. Should the slurry stream be too thin, the calorific value for the slurry stream may be too low for the reactor to reach the autoignition point, thus requiring the input of energy and lowering the overall efficiency of a treatment system incorporating SCWO.

In accordance with one or more embodiments, SCWO may be characterized by a high destruction efficiency as it thrives on organics. Without wishing to be bound by any particular theory, the biomass of the activated sludge may be expected to oxide much faster than any carbon adsorption media.

In accordance with one or more embodiments, the activated sludge feed to the SCWO system may be optimized for autothermal operation.

Without wishing to be bound by any particular theory, there exists a balance between treatment volume, fuel processing, treatment efficacy, and cost that is to be considered when determining the choice of removal materials, upstream treatment systems, and decisions from regulatory agencies for use of SCWO reactors. In some embodiments, the flow rate of the activated sludge, adsorption media and/or an oxygen supply level associated with the SCWO process within the SCWO reactor may be adjusted to account for the variations in calorific value of the slurry stream. Without wishing to be bound by any particular theory, for slurry streams of a higher density, a greater flow rate into the SCWO reactor and/or increased flow from an oxygen supply may be used to offset the increased density, which can promote oxidation and reduce clogging of internal components of the SCWO reactor.

In accordance with one or more specific embodiments, system and process trains enable separation and destruction of PFAS. PFAS may be separated from the contaminated water even at low levels using combined bioreactor and PAC to bioaccumulate PFAS on microbial sludge. The microbial sludge and PAC may be oxidized in a SCWO process to mineralize the adsorbed PFAS and generate energy. Concentrating PFAS in bioreactor sludge reduces the water volume to be treated in the SCWO system, resulting in a smaller SCWO unit and lower capital cost. The microbial sludge and PAC provide organic carbon as fuel required for the SCWO process to be potentially self-sustained without the need for an external energy source.

Bioreactors, including membrane bioreactors (MBRs), are energy-efficient and self-sustained systems to remove biodegradable organic compounds in water. Additionally, some studies have shown that extracellular polymeric substances (EPS) and proteins produced by microbial species serve as PFAS binding sites. The EPS matrix contains a wide range of binding regions and sites, such as amine, carboxyl, and hydroxyl groups to adsorb PFAS compounds with different molecular structures and functional groups.

In accordance with one or more specific embodiments, to further improve the PFAS removal efficiency in bioreactors, powder activated carbon (PAC) can be added to the system. Adsorption using activated carbon is one of the most commonly used technologies to separate PFAS. However, the efficiency of this technology strongly depends on competing organic constituents in water matrix. Given that in most water matrices, organic compounds are in order of magnitudes higher concentrations than PFAS, most of the activated carbon PFAS capacity is lost due to the competitive adsorption. Combining PAC adsorption and bioreactor technology allows removal of competing organic compounds to extend the lifetime and capacity of activated carbon for PFAS removal.

Supercritical water oxidation (SCWO) is a technology that oxidizes organic substances at high temperatures and pressures to generate energy without producing any harmful air pollutants such as NOₓ, SO₂, or particulate matter as opposed to thermal incineration. SCWO has also shown promises in complete mineralization of PFAS to CO₂ and HF.

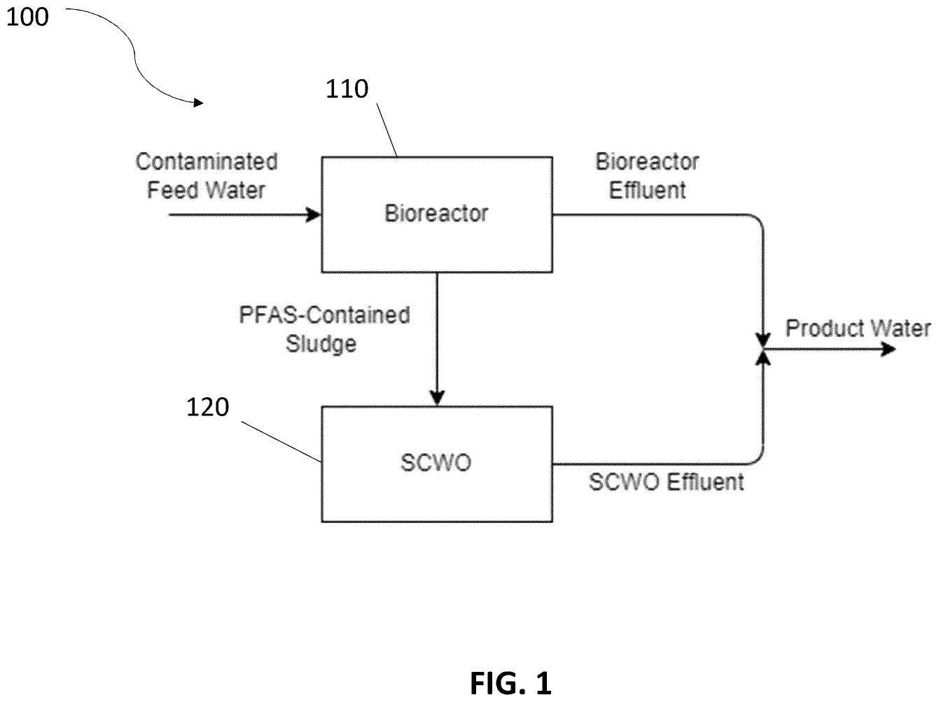

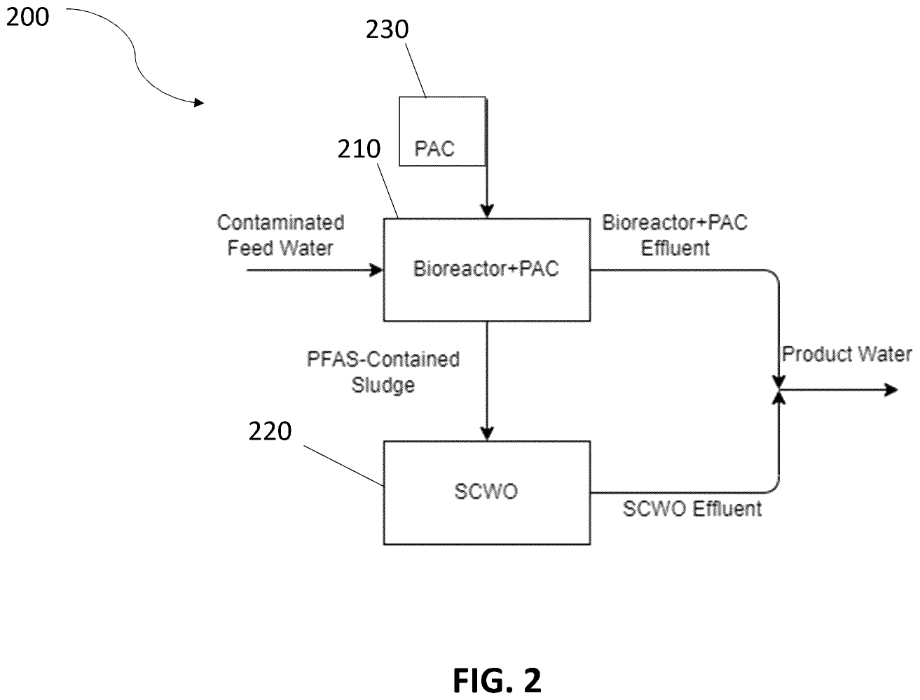

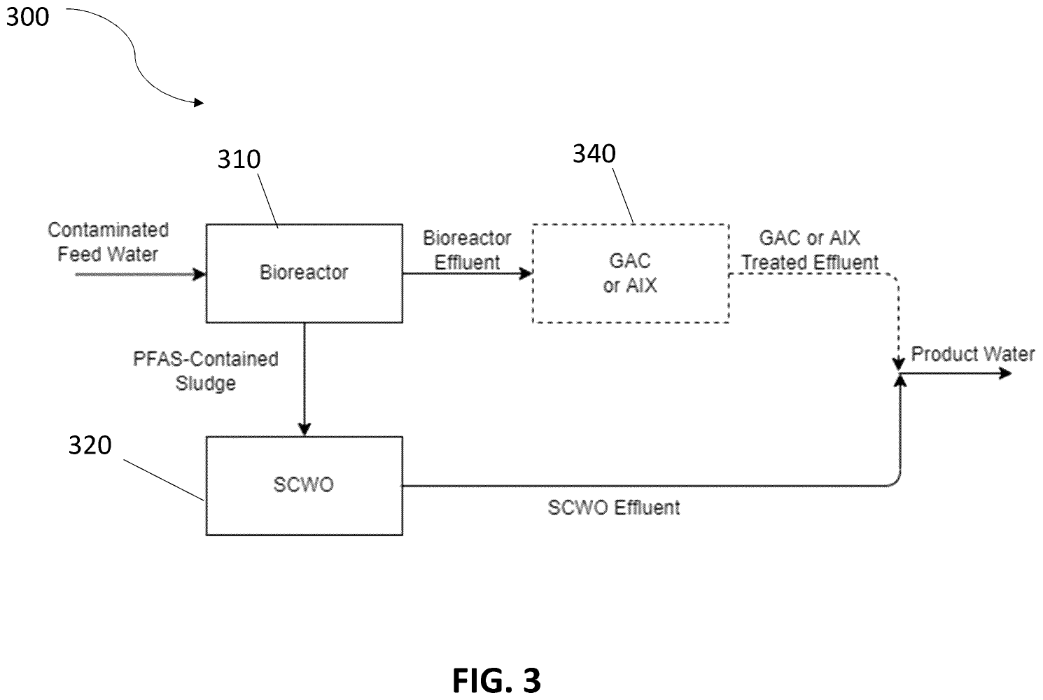

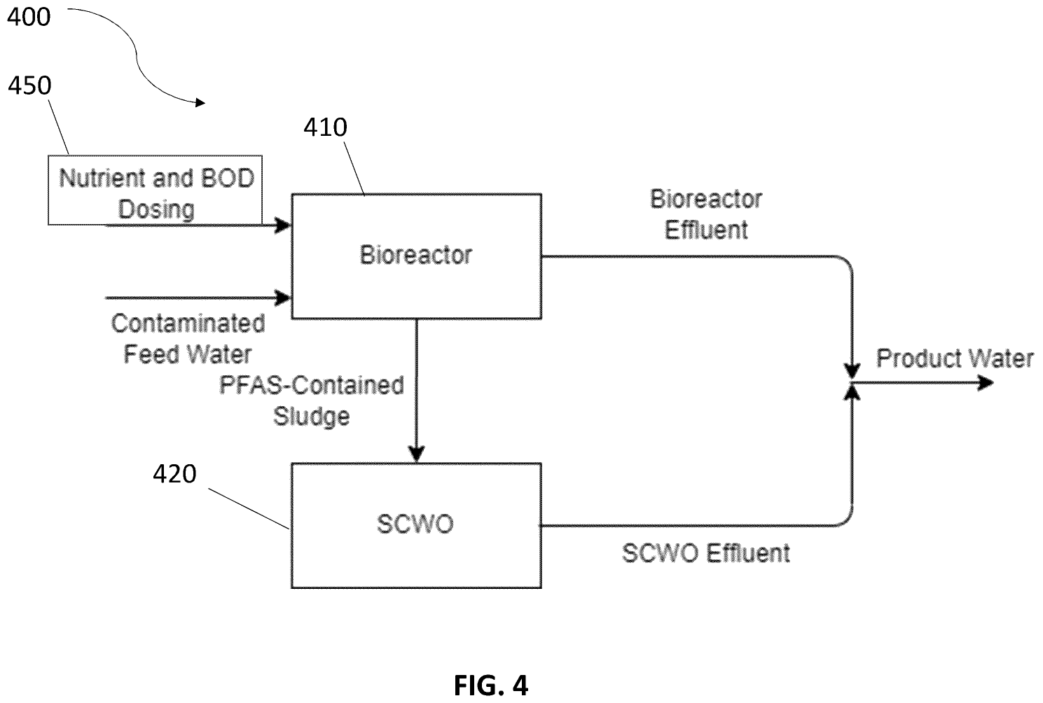

Referring to FIG. 1, a system 100 is illustrated that comprises a bioreactor 110 fluidly connected to a super critical water oxidation (SCWO) apparatus 120. The bioreactor 110 will concentrate PFAS compounds while the SCWO apparatus 120 will mineralize PFAS compounds. Referring to FIG. 2, a source of powdered activated carbon (PAC) 130 is positioned in communication with the bioreactor 210 to improve PFAS concentration. Referring to FIG. 3, activated carbon or ion exchange 140 is fluidly connected to the effluent of the bioreactor 310 to further remove PFAS compounds. Referring to FIG. 4, nutrient dosing 150 is added to the bioreactor 410 in cases where the BOD is insufficient for microorganism growth and to improve the rate of microorganism growth in general. The amount of sludge and PAC being sent to the SCWO apparatus can be controlled so that autothermal operation is achieved.

In accordance with one or more embodiments, spent adsorption media may be reactivated or regenerated for reuse, or instead destroyed. For example, PAC or GAC may be reactivated using heat, or ion exchange resins can be mineralized in kilns operating at temperatures of about 875° C. to 1000° C. or even higher. Optionally, the adsorption column and/or other separation unit operations may be periodically backwashed.

In accordance with one or more embodiments, carbon reactivation includes a method of thermally processing activated carbon, to remove adsorbed components contained within its pores without substantial damage to the original porosity of the carbon. Carbon reactivation is commonly performed by subjecting the carbon to elevated temperatures typically but not limited to temperatures of 700° C. to 800° C. in a controlled atmosphere including water vapor in a rotating kiln or multiple hearth furnace. It can be distinguished from carbon regeneration which may utilize solvents, chemicals, steam, or wet oxidation processes for removal of adsorbed components. During the reactivation process approximately 5% to 10% of the original carbon is reduced to carbon fines or is vaporized.

In some embodiments, systems and methods disclosed herein can be designed for centralized applications, onsite application, or mobile applications via transportation to a site. The centralized configuration can be employed at a permanent processing plant such as in a permanently installed water treatment facility such as a municipal water treatment system. The onsite and mobile systems can be used in areas of low loading requirement where temporary structures are adequate. A mobile unit may be sized to be transported by a semi-truck to a desired location or confined within a smaller enclosed space such as a trailer, e.g., a standard 53′ trailer, or a shipping container, e.g., a standard 20′ or 40′ intermodal container. Beneficially, material containing PFAS need not be transported across a relatively far distance in accordance with various embodiments. Localized removal and destruction is enabled herein.

The function and advantages of these and other embodiments can be better understood from the following example. This example is intended to be illustrative in nature and is not considered to be in any way limiting the scope of the invention.

### Prophetic Example

PFAS species will sorb onto wastewater sludges at different rates according to type and carbon chain length.

It is estimated that between 50 and 92% of PFAS will sorb to standard aerobic wastewater sludges at Mixed Liquor Suspended Solids (MLSS) levels of 3-5 g/l, depending on chain length. MBRs are able to run to much higher MLSS levels, between 12 and 20 g/l MLSS, so the sorption capacity can be expected to be enhanced.

Anaerobic sludges were found to sorb between 75 and 100% of PFAS depending on suspended solids levels and carbon chain length.

Tests have shown a degradation of between 3 and 5 log of PFAS sorbed to powdered activated carbon (PAC) when treated by SCWO. Biosolids are more readily oxidized than PAC, so destruction in sludge is expected to be at least at this level. PFAS removal down to below detectable levels is achieved in accordance with various embodiments.

Activated carbon has a high removal rate until breakthrough with removal rate dependent on the type of carbon and the species of PFAS (see Table 1).

TABLE 1
Indicative Removal of a Range of PFAS

| | Sorption | | SCWO | | | |
|---|---|---|---|---|---|---|
| | (%) | | Destruction | | Overall removal | |
| | low | high | low | high | low | High |
| Aerobic sludge | 50 | 92 | 99.9 | 99.999 | 49.95 | 91.999 |
| Anaerobic sludge | 72 | 100 | 99.9 | 99.999 | 71.93 | 99.999 |
| Aerobic sludge | 99 | 99.9 | 99.9 | 99.999 | 98.90 | 99.899 |
| with PAC | | | | | | |

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

1. A method of treating water containing per- and polyfluoroalkyl substances (PFAS), comprising:
introducing the water containing PFAS to a bioreactor to produce an activated sludge containing adsorbed PFAS, wherein the PFAS is bioaccumulated on the activated sludge;
subjecting the activated sludge containing adsorbed PFAS to a supercritical water oxidation (SCWO) system.

2. The method of claim 1, wherein the PFAS comprise perfluorooctane sulfonic acid (PFOS) or perfluorooctanoic acid (PFOA).

3. The method of claim 1, wherein the water containing PFAS is defined by a chemical oxygen demand (COD) level of at least about 200 mg/L or a biochemical oxygen demand (BOD) level of at least about 100 mg/L.

4. The method of claim 1, wherein the water containing PFAS is defined by a total organic carbon (TOC) level of at least about 75 mg/L.

5. The method of claim 1, further comprising dosing nutrient and/or biological oxygen demand (BOD) to the bioreactor.

6. The method of claim 1, further comprising introducing adsorption media to the water containing PFAS or to the activated sludge containing adsorbed PFAS.

7. The method of claim 6, wherein the adsorption media is a carbon-based media.

8. The method of claim 7, wherein the adsorption media is a powdered activated carbon (PAC).

9. The method of claim 7, wherein the adsorption media comprises a cyclodextrin (CD).

10. The method of claim 1, further comprising dewatering the activated sludge containing adsorbed PFAS prior to the SCWO system.

11. The method of claim 1, further comprising concentrating the water containing PFAS upstream of the bioreactor.

12. The method of claim 1, further comprising introducing a selective ion to the SCWO system.

13. The method of claim 6, further comprising adjusting the dosage of adsorption media based on at least one quality parameter of the water containing PFAS.

14. The method of claim 1, further comprising adjusting a flow rate of the activated sludge containing adsorbed PFAS and/or an oxygen supply level associated with the SCWO system.

15. The method of claim 1, wherein the SCWO system is operated at a temperature of at least about 374° C.

16. The method of claim 15, wherein the SCWO system is operated at a pressure of at least about 221 bar.

17. The method of claim 1, wherein the SCWO system is operated at autothermal conditions.

18. The method of claim 1, further comprising preheating the water containing PFAS and/or the activated sludge containing adsorbed PFAS upstream of the SCWO system.

19. The method of claim 1, further comprising delivering product water at an outlet of the SCWO system to a downstream unit operation for polishing.

20. The method of claim 1, further comprising separating byproducts including nitrogen oxides (NOₓ) and/or sulfur oxides (SOₓ) and/or inorganic ash from product water at an outlet of the SCWO system.

21.-33. (canceled)
